(19) United States
(12) Patent Application Publication
(10) Pub. No.: US 2018/0208490 A1
(43) Pub. Date: Jul. 26, 2018

(54) ENERGY HYDROGEN WATER DISSOLVING DEVICE

(71) Applicant: PING-JUI HAN, TAOYUAN (TW)

(72) Inventor: PING-JUI HAN, TAOYUAN (TW)

(21) Appl. No.: 15/448,842

(22) Filed: Mar. 3, 2017

(30) Foreign Application Priority Data
Jan. 25, 2017 (TW) 106201377

(51) Int. Cl. C02F 1/68; C02F 1/44; B01D 61/00; B01D 29/56; C02F 1/28; B01D 15/08; B01D 36/00; B01D 63/02; B01F 3/04; B01F 5/12; B01F 3/20; C02F 1/00

(52) U.S. Cl. CPC C02F 1/685; C02F 1/44; B01D 61/00; B01D 29/56; C02F 1/283; B01D 15/08; C02F 2103/06; B01D 63/02; B01F 3/0446; B01F 5/12; B01F 3/2057; C02F 1/005; C02F 2209/03; B01D 36/00

(57) ABSTRACT

Disclosed is an energy hydrogen water dissolving device that passes a clean water source through a pressurized pump. A part of the water is sent to a hydrogen production equipment and decomposed into hydrogen and oxygen, and the other part of the water is driven to an energy hydrogen water dissolving and storage tank. The oxygen formed by the hydrogen production equipment is discharged to the outside or returned to the clean water source, and the hydrogen formed by the hydrogen production equipment is connected and sent to an input end of the pressurized pump, pressurized and mixed uniformly by the pressurized pump and outputted to the clean water, so that the water liquid entering into the energy hydrogen water dissolving and storage tank becomes high dissolution hydrogen water. The energy hydrogen water dissolving and storage tank contains an energy mineral, a hydrogen molecule mineral and a terminal filter, and the water liquid discharged from the energy hydrogen water dissolving and storage tank is formed into healthy drinking water with tiny water molecules, weak alkaline, high negative potential and high dissolution hydrogen molecules

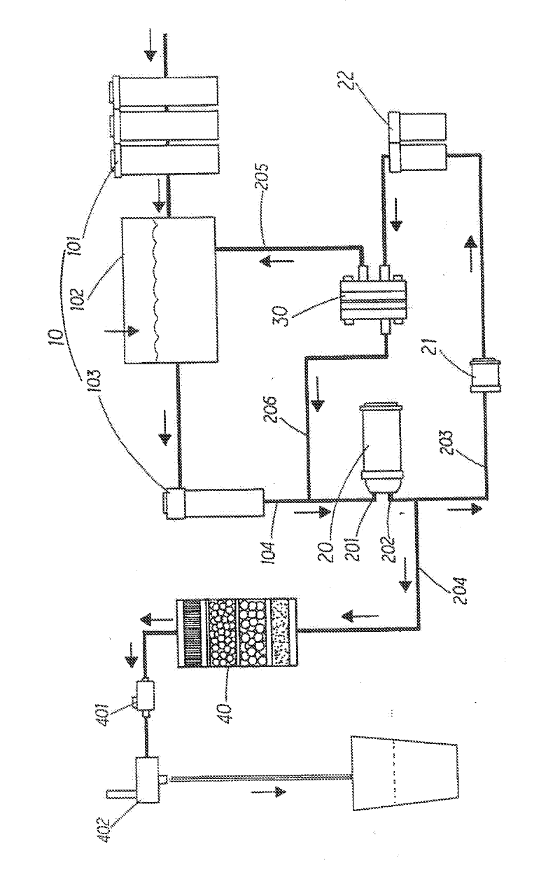

### FIELD OF INVENTION

The present invention relates to an energy hydrogen water dissolving device, particularly to the energy hydrogen water dissolving device with simple configuration, easy installation, and convenient operation and capable of producing healthy drinking water with tiny water molecules, weak alkaline, high negative potential and high dissolution hydrogen molecules after processing a clean water source through a pressurized pump, a hydrogen production equipment, and an energy hydrogen water dissolving and storage tank.

### BACKGROUND OF INVENTION

### 1. Description of the Related Art

Water is the source of life, but water pollution becomes increasingly serious with the high development of industry and commerce. For example, all kinds of heavy metals, industrial wastes, pesticides, chemical agents, animal husbandry wastes, etc contaminate the water. Not just our dependency on a variety of agricultural, fish, and animal husbandry products are contaminated only, but our health is also jeopardized indirectly. Particularly, when our drinking water is polluted directly, people consuming the drinking water for long-term will unknowingly accumulate toxins just like chronic poisoning that leads to illnesses such as high blood pressure, cancer, diabetes, high cholesterol, kidney diseases, and other diseases.

According to various information and documents, there is still a number of longevity villages existed, and a long-term follow-up study conducted by the World Health Organization found that the water used in the longevity village is not just clean and free of pollution only, but it is also slightly alkaline and carries small molecular groups of calcium ions. In addition, the water also has an appropriate oxygen content and good osmotic pressure, solubility, thermal conductivity, and electrical conductivity. The production of the quality water of the longevity village was studied, and such water is produced after rainwater passes through high mountains and soils and enters into ore veins, and the raw water is exchanged and filtered by layers of rocks and ore veins, so that water, and various kinds of ionic minerals and trace elements are filled into the water to form activated energy water.

However, the water quality of the general tap water and groundwater is not as beneficial as the foregoing activated energy water to human beings.

(1) Most water sources of the tap water are affected by industrial, agricultural and animal husbandry pollutions, and water often carries different kinds of heavy metals, residual pesticides, chemical compounds and toxic substances. To achieve a clear water quality, water plants generally add polyaluminum chloride and use chlorine for disinfection, but such compounds will form trihalomethanes after being heated to 60 degrees Centigrade or higher and produce carcinogenic substances, and the water is changed to dead water with large groups of water molecules which affects our metabolic functions.

(2) Groundwater comes from unknown sources, and its use has a higher risk. Particularly, some compounds, heavy metals and pesticides produce toxins which cannot be removed by high-temperature boiling, so that the drinking water has potential risks and unknown illnesses to humans, and the risk of getting chronic diseases will increase.

In addition, free radicals have the properties of high activity, strong oxidation and reactions with other molecules. As to human bodies, free radicals may damage tissues and cells of human bodies and cause chronic diseases or ageing. Therefore, it is believed that free radicals in human bodies bring the issues of cancers.

In addition, researches indicate that hydrogen can neutralize free radicals in human body. Although human bodies can produce hydrogen to neutralize in vivo free radicals, so as to protect damaged cells or maintain normal metabolism. Since the rate of producing hydrogen by human body is not as high as the rate of producing free radicals, so that the balance of in vivo free radicals often cannot be maintained, and human health may be affected easily.

In recent years, some manufacturers attempt different methods or use different equipments to supply hydrogen to human body and maintain good health. Since hydrogen is a gas and it is not easy for human body to absorb hydrogen effectively, therefore the most common method adopted at present is to mix the hydrogen with water, so as to form drinking hydrogen water suitable for drinking. For example, alkaline activated hydrogen water may be used for reducing the oxidation of water, and some researches show that drinking hydrogen water is helpful to human health.

However, most manufacturing equipments for producing hydrogen water comes with a large volume and has the disadvantages of high cost, complicated structure and low mixing effect. In some of the equipments, it requires a long mixing time and thus results in poor hydrogen dissolution efficiency. Obviously, the conventional hydrogen mixing and producing equipments require further improvements.

In view of the drawbacks of the prior art and the tap water and groundwater being common water sources at present, finding a way to purify and producing energy activated water with high content of hydrogen molecules by a simple process is a common goal for related manufacturers.

### 2. Summary of the Invention

In view of the aforementioned drawbacks of the prior art, the inventor of the present invention based on years of experience in the related industry to conduct extensive research and experiment, and finally developed an energy hydrogen water dissolving device in accordance with the present invention to overcome the drawbacks of the prior art.

Therefore, it is a primary objective of the present invention to overcome the drawbacks of the prior art by providing an energy hydrogen water dissolving device, so that after raw water such as tap water or groundwater are processed, purified to form health drinking water with weak alkaline, tiny water molecules, high negative potential (ORP) and high dissolution hydrogen molecules.

To achieve the aforementioned and other objectives, the present invention passes a clean water source through a pressurized pump, and then a part of the water is sent to a hydrogen production equipment and decomposed into hydrogen and oxygen, and the other part of the water is driven to an energy hydrogen water dissolving and storage tank, wherein the oxygen produced by the hydrogen production equipment can be discharged to the outside or returned to the clean water source, and the hydrogen formed by the hydrogen production equipment is connected and sent to an input end of the pressurized pump, so that the hydrogen is pressurized and mixed uniformly by the pressurized pump, and outputted in the clean water, so that the liquid entering into the energy hydrogen water dissolving and storage tank becomes high dissolution hydrogen water. In addition, the energy hydrogen water dissolving and storage tank contains an energy mineral, a hydrogen molecule mineral and a terminal filter, so that the liquid discharged from the energy hydrogen water dissolving and storage tank is formed into health drinking water with tiny water molecules, weak alkaline, high negative potential and high dissolution hydrogen water.

The above and other objects, features and advantages of this disclosure will become apparent from the following detailed description taken with the accompanying drawings.

### BRIEF DESCRIPTION OF THE DRAWING

The FIGURE is a schematic planar view of a preferred embodiment of the present invention.

### DESCRIPTION OF THE PREFERRED EMBODIMENTS

With reference to the FIGURE for an energy hydrogen water dissolving device of the present invention, the energy hydrogen water dissolving device comprises a water purification device 10 including a front filter 101, a water storage tank 102 and a middle filter 103 and capable of filtering and purifying raw water such as tap water or groundwater to form clean water suitable for drinking, wherein the front filter 101 comes with a plural quantity and these front filters 101 are capable of preliminarily filtering the raw water, absorbing impurities, chlorine, and smelly substances in water, reducing the rate of bacteria growth and improving the quality and taste of water. The water storage tank 102 is provided for accommodating clean water or external clean water passing through the front filter 101. The middle filter 103 may be an activated carbon fiber filter (containing zinc PP activated carbon cloth filter) for further filtering tiny impurities in the water. The clean water filtered and purified by the water purification device 10 is connected to the an input end 201 of the pressurized pump 20 through a first connecting pipe 104, the clean water sucked by the pressurized pump 20 is pressurized and outputted, and a part of the clean water is sent from an output end 202 of the pressurized pump 20 to a hydrogen production equipment 30 through a second connecting pipe 203, and the other part of the clean water is driven from the output end 202 of the pressurized pump 20 to an energy hydrogen water dissolving and storage tank 40 through a third connecting pipe 204; wherein after the clean water is passed through the hydrogen production equipment 30 and decomposed into oxygen and hydrogen, and the oxygen so formed is returned into the water storage tank 102 of the water purification device 10 through a fourth connecting pipe 205 or discharged to the outside, and the hydrogen so formed is connected to an input end 201 of the pressurized pump 20 through a fifth connecting pipe 206 and sucked together with the clean water outputted from the first connecting pipe 104 by the pressurized pump 20, so that the hydrogen and water are mixed to form high dissolution hydrogen water which is driven through the output end 202 and the third connecting pipe 204 of the pressurized pump 20 to the energy hydrogen water dissolving tank 40. The energy hydrogen water dissolving tank 40 contains an energy mineral, a hydrogen molecule mineral and a terminal filter. After the high dissolution hydrogen water outputted from the pressurized pump 20 is entered into the energy hydrogen water dissolving and storage tank 40, the raw water is further sterilized and disinfected to form and discharge healthy drinking water with tiny water molecules, weak alkaline, high negative potential (ORP) and high dissolution hydrogen molecules. Wherein, the energy mineral includes a light wave energy stone, an anion stone, a meaical stone, a far infrared ceramic stone and various lodestones; the hydrogen molecule mineral is a magnesium mineral; and the terminal filter is a hollow fiber membrane having 0.01˜0.1 micron ultrafine filter pores on a surface of the fiber membrane.

After the healthy drinking water contained in the energy hydrogen water dissolving and storage tank 40 is passed through a high pressure valve 401 and discharged from a faucet 402, so that the pressure of the drinking water discharged from the faucet 402 can be set. In other words, the high pressure valve 401 controls and turns on or off the pressurized pump 20 by a predetermined pressure, so that when the faucet 402 is opened to discharge the water liquid contained in the energy hydrogen water dissolving and storage tank 40 to the outside through the high pressure valve 401, and the pressurized pump 20 is turned on immediately to sent the high dissolution hydrogen water to the energy hydrogen water dissolving and storage tank 40 and release the pressure gradually, and when the faucet 402 is shut and the predetermined pressure of the water at the high pressure valve 401 is reached, the high pressure valve 402 controls the pressurized pump 20 to stop, so that the energy hydrogen water dissolving and storage tank 40 can maintain the predetermined water pressure all the time.

The clean water is sent to the hydrogen production equipment 30 through the output end 202 and the second connecting pipe 203 of the pressurized pump 20. The water is controlled by the solenoid valve 21 and filtered by the purification filter 22 before entering into the hydrogen production equipment 30, so that the hydrogen formed by the hydrogen production equipment 30 has the cleaning effect, wherein the solenoid valve 21 can control the water intake according to the water level set by the hydrogen production equipment 30, and the hydrogen production equipment 30 can produce and supply hydrogen into the pressurized pump 20 continuously.

Since the hydrogen formed by the hydrogen production equipment 30 is connected to an input end 201 of the pressurized pump 20 through a fifth connecting pipe 206 and sucked together with the clean water purified by the water purification device 10 by the pressurized pump 20. As a result, the hydrogen and clean water are sucked by the high pressure of the pressurized pump 20 and discharged to the outside, and a good uniform mixing effect is achieved, and the high dissolution hydrogen water so formed is entered into the energy hydrogen water dissolving and storage tank 40.

In the present invention, the raw water such as tap water or groundwater is filtered and purified by the water purification device 10 to form clean water. Since the clean water can be sucked by the pressurized pump 20, and a part of the clean water is sent to the hydrogen production equipment 30 and decomposed to produce hydrogen, and the hydrogen formed by the hydrogen production equipment 30 may be sucked together with the clean water by the pressurized pump 20 and then pressurized, mixed and sent into the energy hydrogen water dissolving and storage tank 40. Therefore, the hydrogen can be mixed sufficiently and uniformly with the clean water to form high dissolution hydrogen water suitable for drinking. Since the energy hydrogen water dissolving and storage tank 40 at least contains an energy mineral, a hydrogen molecule mineral and a terminal filter, the raw water can be sterilized and disinfected after the high dissolution hydrogen water pressurized and outputted by the pressurized pump 20 is entered into the energy hydrogen water dissolving and storage tank 40, so as to produce a water liquid with tiny water molecules, weak alkaline, high negative potential and high dissolution hydrogen molecules. Drinking the water liquid discharged from the energy hydrogen water dissolving and storage tank 40 has the expected effect of keeping our body healthy.

In other words, the present invention has the following advantages:

1. The invention features simple manufacture, and excellent cost effectiveness.

2. The invention is simple, easy, convenient, and quick to assemble and operate.

3. The invention has excellent effects on filtering, purifying and disinfecting raw water such as tap water and groundwater.

4. The invention sufficiently and uniformly mixes hydrogen with clean water to form high dissolution hydrogen water.

5. The high dissolution hydrogen water is formed into healthy drinking water with tiny water molecules, weak alkaline, high negative potential and high dissolution hydrogen molecules.

While the invention has been described by means of specific embodiments, numerous modifications and variations could be made thereto by those skilled in the art without departing from the scope and spirit of the invention set forth in the claims.

What is claimed is:

1. An energy hydrogen water dissolving device, comprising a water purification device, a pressurized pump, a hydrogen production equipment and an energy hydrogen water dissolving and storage tank, characterized in that the water purification device has a first connecting pipe coupled to an input end of the pressurized pump, and an output end of the pressurized pump has a second connecting pipe coupled to the hydrogen production equipment, and the output end of the pressurized pump has a third connecting pipe coupled to the energy hydrogen water dissolving and storage tank, and the hydrogen production equipment has a fourth connecting pipe coupled to the input end of the pressurized pump, and the hydrogen produced by the hydrogen production equipment and the clean water outputted from the water purification device are jointly entered and mixed in the pressurized pump to form high dissolution hydrogen water which passes through the third connecting pipe and enters into the energy hydrogen water dissolving and storage tank.

2. The energy hydrogen water dissolving device of claim 1, wherein the water purification device comprises a front filter, a water storage tank, and a middle filter.

3. The energy hydrogen water dissolving device of claim 1, wherein the oxygen decomposed and produced by the hydrogen production equipment is returned to the water purification device or discharged to the outside.

4. The energy hydrogen water dissolving device of claim 1, wherein the clean water transmitted by the pressurized pump to the hydrogen production equipment is controlled up to a predetermined water level by a solenoid valve and filtered by the purification filter before entering into the hydrogen production equipment.

5. The energy hydrogen water dissolving device of claim 1, wherein the drinking water in the energy hydrogen water dissolving and storage tank is passed through the high pressure valve and then discharged from a faucet.

6. The energy hydrogen water dissolving device of claim 1, wherein the energy hydrogen water dissolving and storage tank contains an energy mineral, a hydrogen molecule mineral, and a terminal filter.

7. The energy hydrogen water dissolving device of claim 2, wherein the water storage tank is provided for accommodating the clean water filtered by the front filter or external clean water.

8. The energy hydrogen water dissolving device of claim 2, wherein the middle filter is an activated carbon fiber filter.

9. The energy hydrogen water dissolving device of claim 5, wherein the high pressure valve controls the pressurized pump to be turned on or off by a predetermined pressure.

10. The energy hydrogen water dissolving device of claim 6, wherein the energy mineral is one selected from the group consisting of a light wave energy stone, an anion stone, a meaical stone, a far infrared ceramic stone and various lodestones.

11. The energy hydrogen water dissolving device of claim 6, wherein the hydrogen molecule mineral is a magnesium mineral.

12. The energy hydrogen water dissolving device of claim 6, wherein the terminal filter is a hollow fiber membrane having 0.01˜0.1 micron ultrafine pores on a surface of the terminal filter.
